(19) United States
(12) Patent Application Publication
(10) Pub. No.: US 2015/0023545 A1
(43) Pub. Date: Jan. 22, 2015

(54) Speaker Magnetic Circuit

(71) Applicant: JVC Kenwood Corporation, Yokohama-shi (JP)

(72) Inventor: Hiroyuki KUMAKURA, Yokohama-shi (JP)

(73) Assignee: JVC Kenwood Corporation, Yokohama-shi (JP)

(21) Appl. No.: 14/307,704

(22) Filed: Jun. 18, 2014

(30) Foreign Application Priority Data
Jul. 19, 2013 (JP) 2013150371
Mar. 10, 2014 (JP) 2014046071

(51) Int. Cl. H04R 15/00; H04R 3/00

(52) U.S. Cl. CPC H04R 15/00; H04R 3/00
USPC 381/412

(57) ABSTRACT

A yoke includes a disk-like base end portion and a columnar center pole protruding from a center portion of the base end portion. An annular magnet is arranged on the base end portion. An annular top plate is arranged on the magnet so that an inner circumferential surface thereof is opposite to an outer circumferential surface of the center pole. A non-magnetic ring member is arranged on an inner circumferential surface side of the magnet, the non-magnetic ring member having a same inner circumferential diameter as an inner circumferential diameter of the top plate.

### CROSS REFERENCE TO RELATED APPLICATION

This application is based upon and claims the benefit of priority under 35U.S.C.§119 from Japanese Patent Application No. 2013-150371, filed on Jul. 19, 2013 and No. 2014-046071, filed on Mar. 10, 2014, the entire contents of both of which are incorporated herein by reference.

### BACKGROUND

The present disclosure relates to a speaker magnetic circuit.

As described in Japanese Patent Laid Open Publication No. H08-9494 (Patent Literature 1), a magnetic circuit of a general external magnetic-type speaker includes a top plate, a magnet, and a yoke. From the center of the yoke, a center pole protrudes. Between an inner circumferential surface of the top plate and an outer circumferential surface of the center pole, a magnetic gap is formed. In the magnetic gap, a voice coil wound around a voice coil bobbin is arranged.

Japanese Patent Laid Open Publication No. 2009-124200 (Patent Literature 2) describes that, in order to enhance heat radiation of the speaker, air from a diaphragm is guided to a cover that covers the magnetic circuit, and the magnetic circuit is cooled. Japanese Patent Laid-Open Publication No. 2006-60443 (Patent Literature 3) describes that a heat radiating member is installed on the top plate to thereby cool down the top plate. Japanese Patent Laid-Open Publication No. 2005-341475 (Patent Literature 4) describes that heat radiating components are installed on and under the top plate.

In accordance with such technologies described in Patent Literatures 2 to 4, heat from the voice coil is drawn indirectly, whereby the voice coil can be cooled down.

### SUMMARY

In accordance with the above-described technologies, heat from the voice coil at a portion that is located in the magnetic gap formed between the top plate and the yoke can be drawn. However, in the above-described technology, heat from the voice coil at a portion that is not located in the magnetic gap cannot be drawn, and heat from the whole of the voice coil cannot be dissipated.

The inventor of the present disclosure has inspected a heat failure of the speaker, and then it was found that the voice coil at the portion that is not located in the magnetic gap frequently causes a layer to short circuit. This indicates that the heat from the voice coil at the portion that is not located in the magnetic gap is not dissipated sufficiently.

It is an object of the embodiments to provide a speaker magnetic circuit capable of effectively radiating the heat from the voice coil and thereby enhancing heat resistance of the voice coil.

An aspect of the embodiments provides a speaker magnetic circuit comprising: a yoke including a disk-like base end portion and a columnar center pole protruding from a center portion of the base end portion; an annular magnet arranged on the base end portion; an annular top plate arranged on the magnet so that an inner circumferential surface thereof is opposite to an outer circumferential surface of the center pole; and a non-magnetic ring member arranged on an inner circumferential surface side of the magnet, the non-magnetic ring member having a same inner circumferential diameter as an inner circumferential diameter of the top plate.

### BRIEF DESCRIPTION OF THE DRAWINGS

FIG. 1 is a cross-sectional view of a speaker magnetic circuit of a first embodiment, showing a position of a voice coil when the voice coil is turned to a non-energized state.

FIG. 2 is a cross-sectional view of the speaker magnetic circuit of the first embodiment, showing a position of the voice coil when the voice coil is turned to an energized state.

FIG. 3 is a perspective view showing a non-magnetic ring member for use in the speaker magnetic circuit of the first embodiment.

FIG. 4 is a cross-sectional view showing a speaker unit for use in the speaker magnetic circuit of the first embodiment.

FIG. 5 is a perspective view showing a non-magnetic ring member for use in a speaker magnetic circuit of a second embodiment.

FIG. 6 is a perspective view showing a non-magnetic ring member for use in a speaker magnetic circuit of a third embodiment.

### DETAILED DESCRIPTION

A description is made below in detail of the speaker magnetic circuits of the first to third embodiments with reference to the accompanying drawings. For the sake of convenience, a vertical direction in the drawings is defined as a vertical direction of the speaker magnetic circuits or speaker units.

### First Embodiment

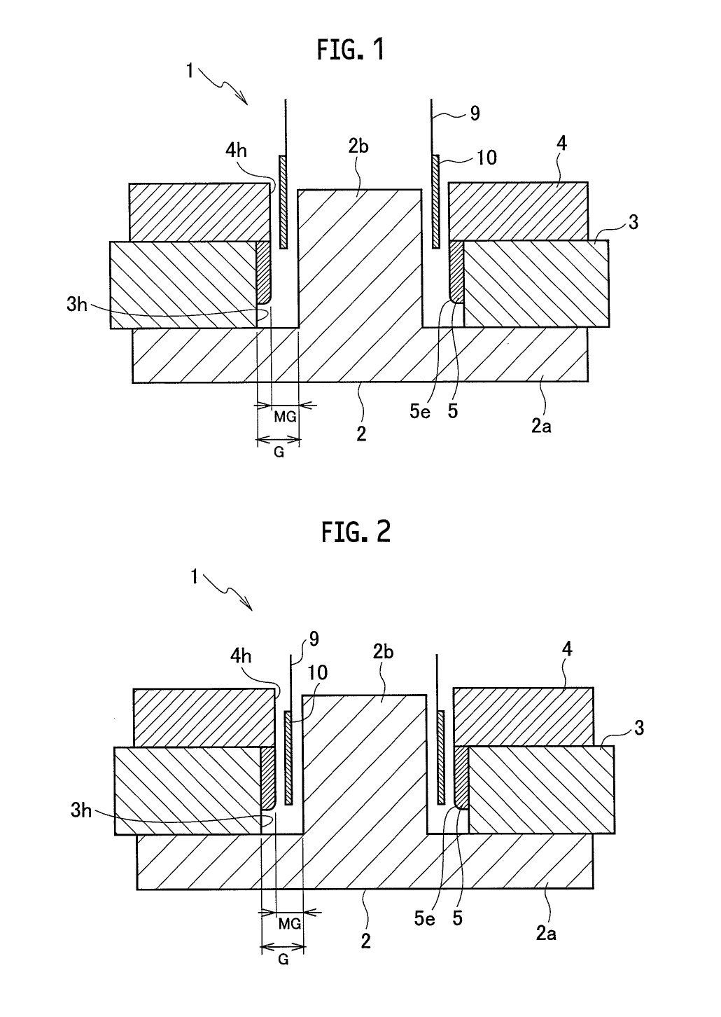

As shown in FIG. 1, a speaker magnetic circuit 1 includes a yoke 2, a magnet 3, a top plate 4, and a non-magnetic ring member 5.

The yoke 2 includes: a base end portion 2a formed into a disk shape; and a columnar center pole 2b protruding upward at a center portion of an upper surface of the base end portion 2a. The yoke 2 is composed of a magnetic body.

The magnet 3 is formed into a ring shape having a through hole 3h having a radius obtained by adding a gap G to a radius of the center pole 2b. The magnet 3 is arranged on the base end portion 2a in a state where the center pole 2b penetrates the through hole 3h. The magnet 3 is magnetized on the vertical direction of FIG. 1.

The top plate 4 is formed into a ring shape having a through hole 4h having a radius obtained by adding a magnetic gap MG smaller than the gap G to the radius of the center pole 2b. The top plate 4 is arranged on the magnet 3. The top plate 4 is composed of a magnetic body.

The center pole 2b is inserted into the through hole 4h of the top plate 4. An inner circumferential surface of the top plate 4 is opposite to an outer circumferential surface of the center pole 2b.

The non-magnetic ring member 5 has the same inner circumferential diameter as an inner circumferential diameter of the top plate 4 (that is, a diameter of the through hole 4h). The non-magnetic ring member 5 is arranged so as to be brought into intimate contact with an inner circumferential surface of the magnet 3 and a lower surface of the top plate 4.

A position of the inner circumferential surface of the magnet 3 is located outward in a diameter direction more than a position of the inner circumferential surface of the top plate 4 by a thickness of the non-magnetic ring member 5. Hence, when the non-magnetic ring member 5 is arranged on the inner circumferential surface of the magnet 3, the position of the inner circumferential surface of the top plate 4 and a position of the inner circumferential surface of the non-magnetic ring member 5 substantially coincide with each other.

A corner portion 5e in which the inner circumferential surface of the non-magnetic ring member 5 and a lower end surface thereof intersect with each other is formed into a fillet with a round and smooth curved surface.

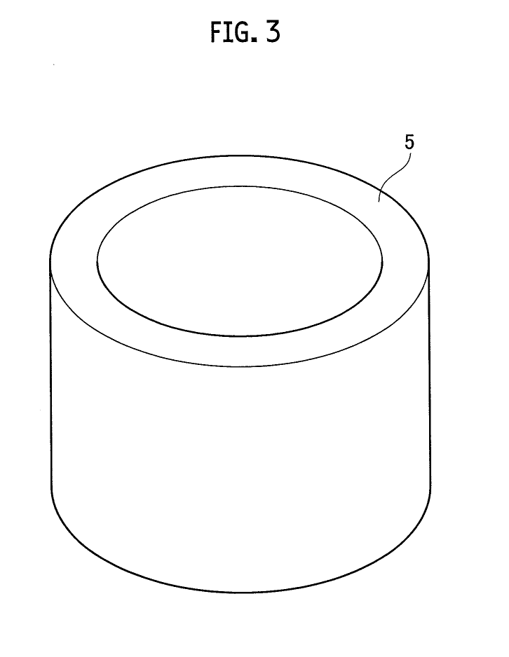

FIG. 3 is a perspective view showing the non-magnetic ring member 5 in the first embodiment. As shown in FIG. 3, the inner circumferential surface of the non-magnetic ring member 5 in the first embodiment is a uniform and smooth surface (surface free from irregularities).

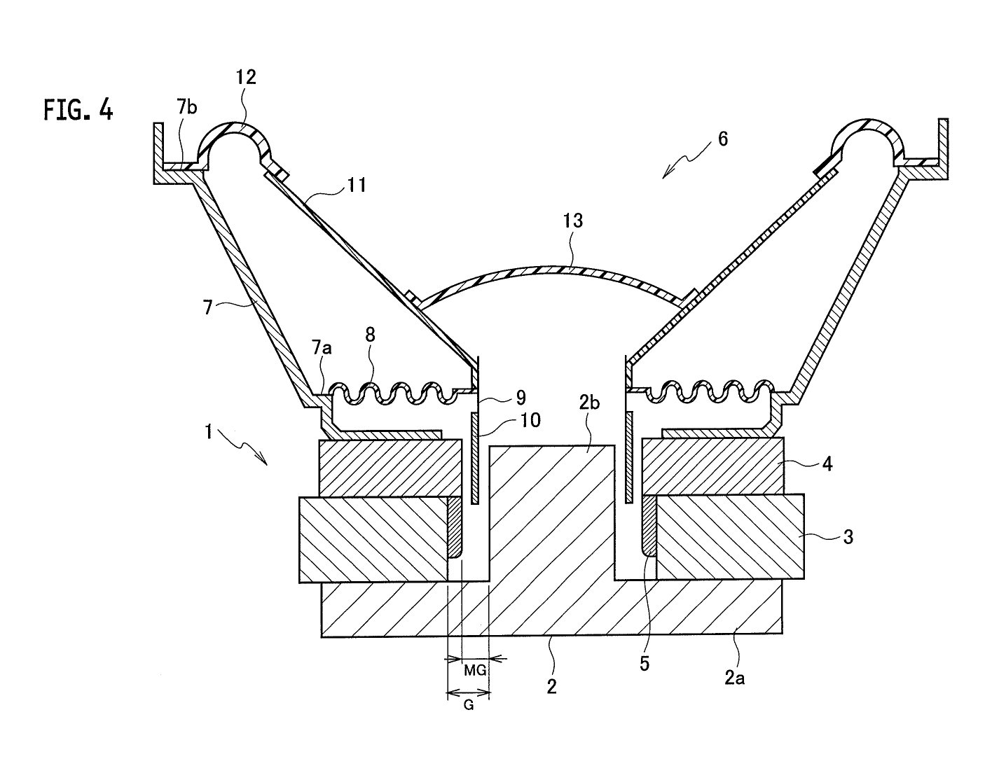

A speaker unit 6 using the speaker magnetic circuit 1 is composed as shown in FIG. 4. A frame 7 formed into a substantially truncated cone shape is fixedly attached onto an upper surface of the top plate 4.

Onto a step portion 7a formed in a lower portion of the frame 7, an outer circumferential portion of an annular damper 8 is fixedly attached. Concentric corrugations are formed in the damper 8. A cylindrical voice coil bobbin 9 is fixedly attached onto an inner circumferential portion of the damper 8.

A voice coil 10 is wound around an outer circumference of the voice coil bobbin 9, which is located below a spot thereof onto which the damper 8 is fixedly attached. The voice coil 10 is wound around the outer circumference concerned in a predetermined range from a lower end portion of the voice coil bobbin 9.

When the voice coil 10 is in a non-energized state, a lower portion of the voice coil bobbin 9 is located in the magnetic gap MG formed between the outer circumferential surface of the center pole 2b and the inner circumferential surface of the top plate 4. With regard to the voice coil 10, an upper portion thereof is not located in the magnetic gap MG, and most of a lower portion thereof is not located in the magnetic gap MG.

An inner circumferential portion of a diaphragm 11 expanded upward in diameter is fixedly attached onto an upper portion of the voice coil bobbin 9. An inner circumferential portion of an annular edge 12 in which a cross-sectional shape is formed into a semicircle is fixedly attached onto an outer circumferential portion of the diaphragm 11. An outer circumferential portion of the edge 12 is fixedly attached onto a step portion 7b formed in an upper portion of the frame 7.

A dome-like cap 13 is fixedly attached onto a halfway portion of the diaphragm 11 so as to close an upper opening of the voice coil bobbin 9.

When an audio signal is inputted to the voice coil 10, and the voice coil 10 is turned to an energized state, then by a function of the magnetic circuit, the voice coil bobbin 9 and the voice coil 10 move vertically in accordance with the audio signal. In such a way, the diaphragm 11 vibrates in the vertical direction, and the speaker unit 6 emits a sound.

FIG. 2 shows a state where the voice coil bobbin 9 is located at a lowest position (base end portion 2a side) thereof at a time of a maximum amplitude by the input of the audio signal to the voice coil 10. A lower end of the non-magnetic ring member 5 (that is, an end portion thereof on the base end portion 2a side) is located more downward than a lower end of the voice coil 10 when the voice coil bobbin 9 is located at the lowest position.

In the state of FIG. 2, with regard to the voice coil 10, the lower portion is not located in the magnetic gap MG, and the upper portion is located in the magnetic gap MG.

The non-magnetic ring member 5 is formed, for example, of metal containing aluminum as a main body. Specifically, the non-magnetic ring member 5 is formed of a non-magnetic body such as aluminum or an aluminum alloy, and does not affect a magnetic flux density in the magnetic gap MG.

As described above, the corner portion 5e on the lower end of the inner circumferential surface of the non-magnetic ring member 5 is formed into the fillet, and accordingly, turbulence owing to such a vertical motion of the voice coil bobbin 9 is less likely to occur.

The gap G composed between the inner circumferential surface of the magnet 3 on a lower portion of the non-magnetic ring member 5 and the center pole 2b is larger than the magnetic gap MG.

In general, when a moving speed of air in contact with an object rises, then a heat transfer rate of the air is increased. This is obvious since a heat transfer rate h defined in Expression (1) is in a proportional relationship with a heat flux density J.

$$h = \frac{Q}{A ( Tw - Ta )} = \frac{J}{Tw - Ta} \qquad ( 1 )$$

In Expression (1), Q is a heat movement (W), J is the heat flux (W/m²), A is a heat transfer area (m²), Tw is a temperature (K) of an object surface, and Ta is a temperature (K) of a fluid, where Tw>Ta.

That is to say, when a moving speed of air in contact with the voice coil 10 rises, then the heat transfer rate of the air is increased. If the moving speed of the air in contact with the voice coil 10 is raised, then the air can draw heat of the voice coil 10 efficiently.

In order to raise the moving speed of the air, a cross-sectional area of a region where the voice coil 10 moves, the cross-sectional area being taken along a direction perpendicular to a moving direction thereof, only needs to be decreased.

As shown in FIG. 1 and FIG. 2, an inner diameter of the magnet 3 is larger than an inner diameter of the top plate 4. The gap G under the magnetic gap MG is larger than the magnetic gap MG. In the first embodiment, the non-magnetic ring member 5 having the same inner circumferential diameter as that of the top plate 4 is arranged on the inner circumferential surface of the magnet 3, and accordingly, the cross-sectional area of the region where the voice coil 10 moves is constant. Hence, in accordance with the speaker magnetic circuit 1 of the first embodiment, the moving speed of the air can be raised in comparison with a case where the non-magnetic ring member 5 is not present, and the heat of the voice coil 10 can be drawn efficiently.

In the first embodiment, the lower end of the non-magnetic ring member 5 does not abut against the base portion 2a of the yoke 2, and the gap G is formed in a vicinity of the base end portion 2a.

If the lower end of the non-magnetic ring member 5 abuts against the base end portion 2a, a compression ratio of the air is increased at a time when the voice coil 10 is lowered, and accordingly, the voice coil 10 becomes difficult to move. By the fact that the gap G is present in the vicinity of the base end portion 2a, the voice coil 10 can be moved smoothly.

Moreover, in a case where a stroke of the voice coil 10 is small since the audio signal is weak, a flow of the air disappears in a lowermost portion of the gap G, and the heat is accumulated. The gap G, which is larger than the magnetic gap MG, and is present in the vicinity of the base end portion 2a, becomes an air chamber. Hence, circulation of the air occurs, thus making it possible to prevent the accumulation of heat.

In accordance with the speaker magnetic circuit 1 of the first embodiment, the heat of the voice coil 10 is radiated efficiently, thus making it possible to enhance heat resistance of the voice coil 10.

### Second Embodiment

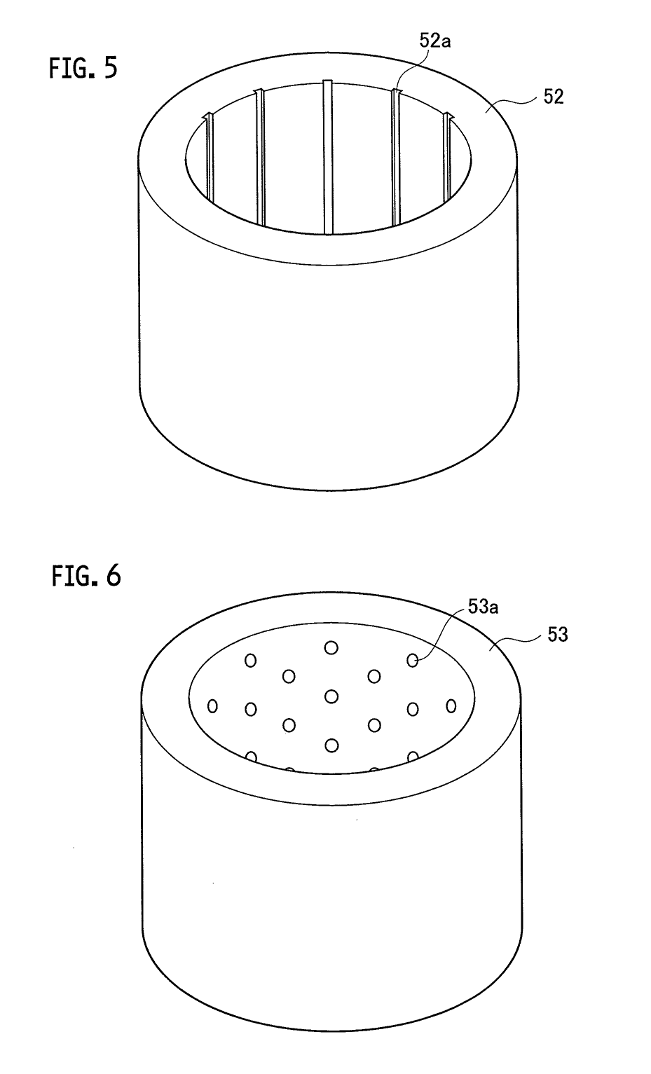

Next, a description is made of the speaker magnetic circuit of the second embodiment with reference to FIG. 5. Here, a description is made of only a point in which the second embodiment is different from the first embodiment, and a duplicate description is omitted.

FIG. 5 is a perspective view of a non-magnetic ring member 52 in the second embodiment. The speaker magnetic circuit of the second embodiment is a circuit in which the non-magnetic ring member 5 in the speaker magnetic circuit 1 of the first embodiment is replaced with the non-magnetic ring member 52.

As shown in FIG. 5, a plurality of longitudinal grooves 52a arrayed in a circumferential direction is provided on an inner circumferential surface of the non-magnetic ring member 52 in the second embodiment. The longitudinal grooves 52a are extended in a direction parallel to the moving direction of the voice coil 10. In an example shown in FIG. 5, the plurality of longitudinal grooves 52a is arrayed at an equal interval in the circumferential direction.

In such a way, while setting such a gap when the voice coil 10 is lowered at the maximum amplitude at the same gap as the magnetic gap MG, a contact area of the air in the gap with the non-magnetic ring member 52 can be increased. Hence, in accordance with the second embodiment, the heat of the voice coil 10 can be drawn efficiently.

In accordance with the speaker magnetic circuit of the second embodiment, the heat of the voice coil 10 is radiated effectively, thus making it possible to enhance the heat resistance of the voice coil 10.

### Third Embodiment

Next, a description is made of the speaker magnetic circuit of the third embodiment with reference to FIG. 6. Here, a description is made of only a point in which the third embodiment is different from the first embodiment, and a duplicate description is omitted.

FIG. 6 is a perspective view of the non-magnetic ring member 53 in the third embodiment. The speaker magnetic circuit of the third embodiment is a circuit in which the non-magnetic ring member 5 in the speaker magnetic circuit 1 of the first embodiment is replaced with the non-magnetic ring member 53.

As shown in FIG. 6, a plurality of dot-like recessed portions 53a are formed on an inner circumferential surface of the non-magnetic ring member 53 in the third embodiment. For example, the recessed portions 53a have a hemispherical shape. In an example shown in FIG. 6, the plurality of recessed portions 53a is arranged uniformly on the inner circumferential surface.

In such a way, while setting such a gap when the voice coil 10 is lowered at the maximum amplitude at the same gap as the magnetic gap MG in a similar way to the second embodiment, a contact area of the air in the gap with the non-magnetic ring member 53 can be increased. Hence, in accordance with the third embodiment, the heat of the voice coil 10 can be drawn efficiently.

In accordance with the speaker magnetic circuit of the third embodiment, the heat of the voice coil 10 is radiated effectively, thus making it possible to enhance the heat resistance of the voice coil 10.

The present invention is not limited to the first to third embodiments described above, and is changeable in various ways within the scope without departing from the spirit of the present invention.

What is claimed is:

1. A speaker magnetic circuit comprising:
a yoke including a disk-like base end portion and a columnar center pole protruding from a center portion of the base end portion;
an annular magnet arranged on the base end portion;
an annular top plate arranged on the magnet so that an inner circumferential surface thereof is opposite to an outer circumferential surface of the center pole; and
a non-magnetic ring member arranged on an inner circumferential surface side of the magnet, the non-magnetic ring member having a same inner circumferential diameter as an inner circumferential diameter of the top plate.

2. The speaker magnetic circuit according to claim 1, further comprising:
a voice coil arranged in a magnetic gap formed between the outer circumferential surface of the center pole and the inner circumferential surface of the top plate,
wherein an end portion of the non-magnetic ring member, the end portion being located on the base end portion side, is located more on the base end side than an end portion of the voice coil, the end portion being located on the base end portion side, when an audio signal is inputted to the voice coil and the voice coil is located most on the base end portion side.

3. The speaker magnetic circuit according to claim 2, wherein, between the end portion of the non-magnetic ring member, the end portion being located on the base end portion side, and the base end portion, a gap larger than the magnetic gap is formed, the gap being formed between the outer circumferential surface of the center pole and an inner circumferential surface of the magnet.

4. The speaker magnetic circuit according to claim 1, wherein the non-magnetic member is formed of metal containing aluminum.

5. The speaker magnetic circuit according to claim 1, wherein an inner circumferential surface of the non-magnetic ring member is a smooth surface free from irregularities.

6. The speaker magnetic circuit according to claim 1, wherein a plurality of longitudinal grooves arrayed in a circumferential direction is formed on an inner circumferential surface of the non-magnetic ring member.

7. The speaker magnetic circuit according to claim 1, wherein a plurality of dot-like recessed portions is formed on an inner circumferential surface of the non-magnetic ring member.
